(19) United States
(12) Patent Application Publication
(10) Pub. No.: US 2016/0182644 A1
(43) Pub. Date: Jun. 23, 2016

(54) Accessing Method and Related Server Device

(71) Applicant: Wistron Corporation, New Taipei City (TW)

(72) Inventors: Hsien-Ta Wu, New Taipei City (TW); Alexander I-Chi Lai, New Taipei City (TW)

(21) Appl. No.: 14/662,230

(22) Filed: Mar. 18, 2015

(30) Foreign Application Priority Data
Dec. 19, 2014 (TW) 103144557

(51) Int. Cl. H04L 29/08

(52) U.S. Cl. CPC H04L 67/141

(57) ABSTRACT

An accessing method, for a server device which does not connect to a network, includes inputting an external command to a baseboard management control module of the server device for triggering the baseboard management control module to generate a first event; triggering a chip module of the server device to generate a second event according to the first event; and accessing, by a server module of the server device, a device component according to the second event.

### BACKGROUND OF THE INVENTION

1. Field of the Invention

The present invention relates to an accessing method utilized in offline state and related server device, and more particularly, to an accessing method for accessing the device component of a server when the server does not connect to the network and related server device.

2. Description of the Prior Art

With the advances in the communication technology, the user can rapidly read and store required information via the network with low transmission delays. In such a condition, the information can be stored in remote servers and does not required to be stored in the personal computer (PC) of the user. When the user needs to use (e.g. read or edit) the information, the user can download the information to the PC. The cost of the user spent on the storage equipment therefore can be reduced. Furthermore, when storing the information on the remote server, the information can be on-line edited by multiple users. Even if the users are at different locations, the users still can work together. The cost of the commutations and time are saved, therefore. In addition, the user may synchronize the information in the computers located at different places via storing the information in the remote server, to keep the information to be the latest version. When the user uses the information at different place, the user can directly use the information of the latest version without considering the version editing history.

The abovementioned service is also called cloud service. In order to provide the cloud service, the industry begins to purchase and configure a large number of servers (i.e. the remote servers), to store the significant amount of user information. The industry is required to configure thousands of servers for providing the cloud services for a large number of users. When configuring the large number of servers, supervisors of the servers may encounter management problems. In general, the supervisor may manage the remote servers via using the serial over local area network (SOL), wherein the SOL is required to fit an intelligent platform management interface (IPMI) protocol. The IPMI protocol is an industry standard developed by Intel. The advantages of the IPMI protocol comprise free, being an open standard and being widely used in the industry, and the disadvantages of IPMI protocol comprises the complex structure and that the companies are hard to customize the management interface and the management method based on their own requirements while satisfying the limitations of the standard. Thus, the industry is dedicated to develop a new remote server management method with low complexity and a feature of easy to use, to overcome the disadvantages of the IPMI protocol.

### SUMMARY OF THE INVENTION

In order to solve the above problem, the present invention provides an accessing method for accessing the device component of a server when the server does not connect to the network and related server device.

In an aspect, the present invention discloses an accessing method, for a server device which does not connect to a network, comprising inputting an external command to a baseboard management control module of the server device for triggering the baseboard management control module to generate a first event; triggering a chip module of the server device to generate a second event according to the first event; and accessing, by a server module of the server device, a device component according to the second event.

In another aspect, the present invention further discloses a server device, comprising a base board management control module, for generating a first event when receiving an external command; a chip module, coupled to the baseboard management control module for generating a second event when receiving the first event; and a server module, coupled to the chip module for accessing a device component when receiving the second event.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a server device according to an embodiment of the present invention.

FIG. 2 is a flowchart of an accessing method according to an embodiment of the present invention.

FIG. 3 is a flowchart of an interrupting method according to an embodiment of the present invention.

FIG. 4 is a flowchart of another accessing method according to an embodiment of the present invention.

### DETAILED DESCRIPTION

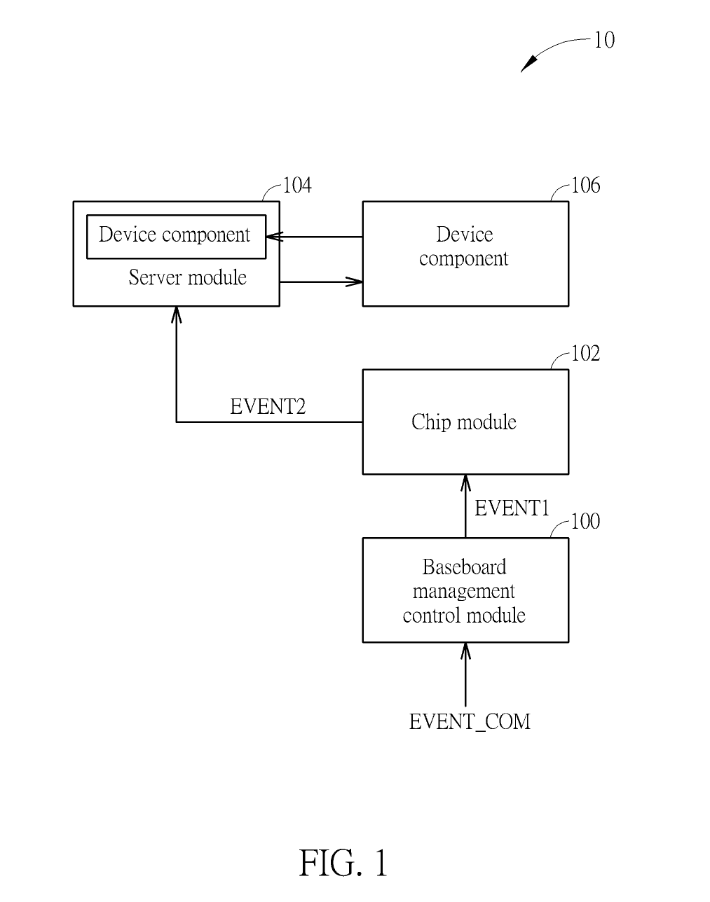

Please refer to FIG. 1, which is a schematic diagram of a server device 10 according to an embodiment of the present invention. The server device 10 may be a server product such as a blade server or a storage server, and is not limited herein. As shown in FIG. 1, the server device 10 comprises a baseboard management control module 100, a chip module 102 and a server module 104. Note that, the components which do not directly relate to the concept of the present invention (e.g. sensors and memories) are not shown in FIG. 1 for brevity. The server device 10 does not connect to the network. That is, the user cannot access data in the server module 104 via the network. In this embodiment, the user transmits an event EVENT1 to the chip module 102 via the baseboard management control module 100. Next, the event EVENT1 may trigger the chip module 102 to transmit an event EVENT2 to the server module 104, or the server module 104 may actively read the event EVENT2. After receiving or reading the event EVENT2, the server module 104 begins to access a device component 106, for storing or updating data to the device components in the server module 104. In other words, the user achieves the goal of accessing the device components in the server module 104 via the baseboard management control module 100.

In details, the baseboard management control module 100 may be a baseboard management controller. The user predefines an external command EVENT_COM used for instructing the server module 104 to accessing the device component 106. For example, the external command EVENT_COM may be defined in the intelligent platform management interface (IPMI) protocols, and is not limited herein. In addition, the user also pre-configures services used for processing the event EVENT2 and performing corresponded commands in the server module 104.

When the server module 104 is offline or the server module 104 crashes, the user transmits the external command EVENT_COM to the baseboard management control module 100. After receiving the external command EVENT_COM, the baseboard management control module 100 transmits the event EVENT1 to the chip module 102. In an embodiment, the chip module 102 receives, analyzes the event EVENT1 and transmits the event EVENT2 to the sever module 104 via the transmission interface between the chip module 102 and the server module 104 (e.g. a Serial Communication Interface (SCI)). In another embodiment, the server module 104 actively reads the event EVENT2. For example, when the server module 104 crashes and works abnormally, the server module 104 may actively read an event queue and perform commands of the events comprised in the event queue (e.g. the event EVENT2) after being reset. Note that, the chip module 102 is a chip module capable of analyzing the event EVENT1 in the server device 10. For example, the chip module 102 may be a south bridge chip module in the server device 10, and is not limited herein.

According to the event EVENT2, the server module 104 performs the corresponded services (e.g. copy commands) to access the device component 106 and to store or update the data to the device components (e.g. storage components or any physical/virtual devices) in the server module 104. As a result, the user accesses and controls the device components in the server module 104 via the baseboard management control module 100, to store or to update data to the device components in the server module 104 when the server module 104 is offline. Further, the user also can reset the server module 104 via the baseboard management control module 100 when the server module 104 crashes and cannot connect to the network. In such a condition, the server module 104 actively read the event queue, to reset settings, to store or to update data to any device component in the server module 104.

In this embodiment, the device component 106 maybe an external physical device capable of being accessed by the server module 104. For example, the device component 106 may be a physical device connected to the chip module 102 via the Universal Serial Bus (USB) interface. In addition, the device component 106 may be a virtual device. For example, the device component 106 may be a virtual device configured in memory components (e.g. Read-Only Memory (ROM)) of the baseboard management control module 100 or the chip module 102.

Via predefining the external command in the baseboard management control module of the server device and pre-configuring the corresponded services in the server module, the above embodiment allows the user to access the device components in the server module through the baseboard management control module. According to different applications and design concepts, those with ordinary skill in the art may observe appropriate alternations and modifications. For example, the server module 104 may transmit state information to the server module 102 and/or the baseboard management control module 100 after performing the commands corresponding to the event EVENT2, wherein the state information is utilized for indicting whether the commands corresponding to the event EVENT2 is performed successfully.

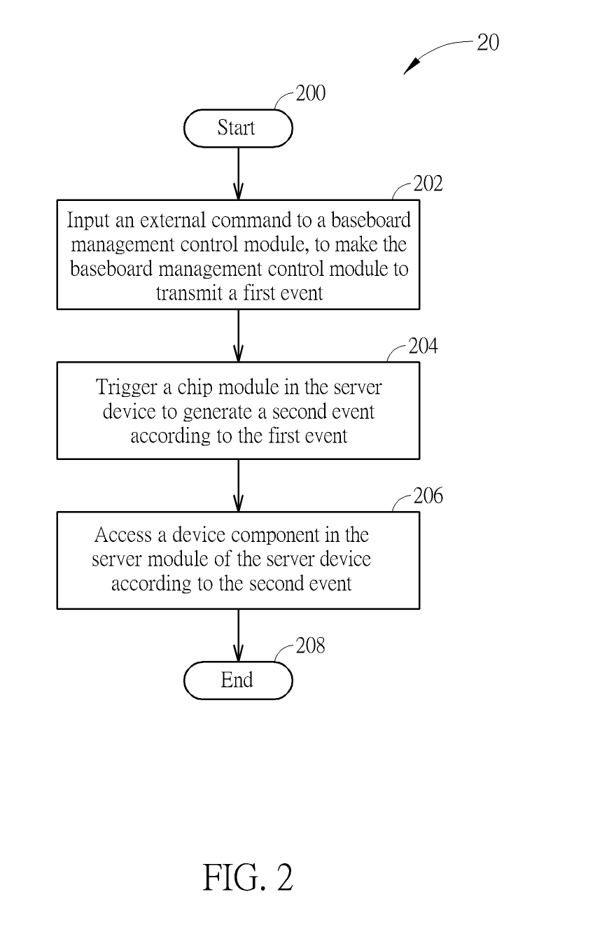

The process of the user accessing the device components in the server module 104 via the baseboard management control module 100 can be summarized into an accessing method 20 shown in FIG. 2. The accessing method 20 is utilized in a server device which does not connect to the network and comprises the following steps:

Step 200: Start.

Step 202: Input an external command to a baseboard management control module, to make the baseboard management control module to transmit a first event.

Step 204: Trigger a chip module in the server device to generate a second event according to the first event.

Step 206: Access a device component in the server module of the server device according to the second event.

Step 208: End.

According to the accessing method 20, the user controls the baseboard management control module to transmit a first event (e.g. the event EVENT1) to a chip module of the server device via inputting an external command pre-defined in the operation firmware of the baseboard management control module. According to the first event, the chip module generates a second event (e.g. the event EVENT2) to a server module in the server device. In such a condition, the server module performs services corresponding to the second event to access data of a device component, wherein the device component may be an external device component coupled to the chip module via a connection interface or a virtual device configured in one of the chip module and the baseboard management control module. As a result, the user can access the device component in the server module via the baseboard management control module and achieve the goal of storing and updating data to the device component in the server module under the condition that the server module is offline. Further, when the server module crashes and cannot build connections to the network, the user also can reset the server module via the baseboard management control module, to reset the setting or access any device component via utilizing the server module to read the event queue.

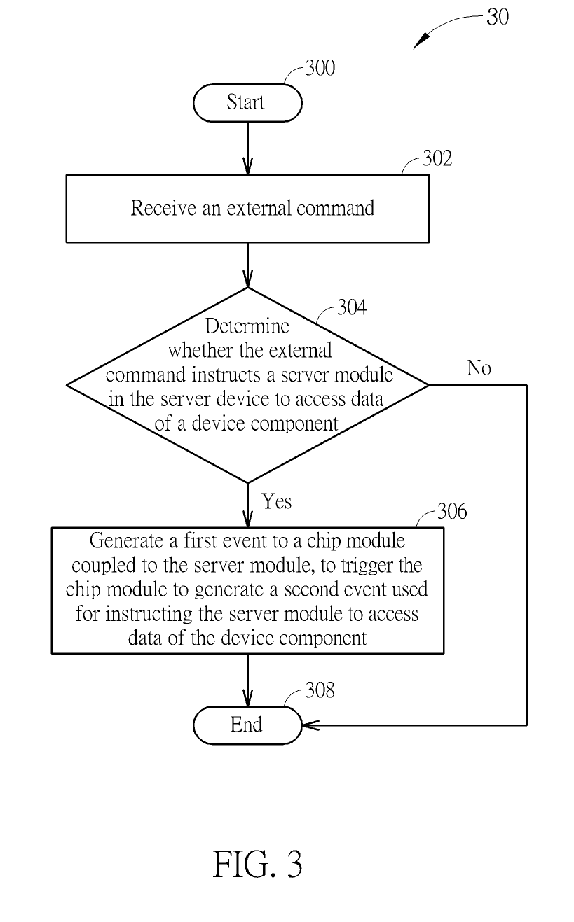

The process of the baseboard management control module 100 transmitting the event EVENT1 can be summarized into an event processing method 30 shown in FIG. 3. The event processing method 30 is utilized in a baseboard management control module (e.g. the baseboard management controller) in the server device and comprises the following steps:

Step 300: Start.

Step 302: Receive an external command.

Step 304: Determine whether the external command instructs a server module in the server device to access data of a device component. If yes, perform step 306; otherwise, perform step 308.

Step 306: Generate a first event to a chip module coupled to the server module, to trigger the chip module to generate a second event used for instructing the server module to access data of the device component.

Step 308: End.

According to the event processing method 30, the user inputs an external command to the baseboard management control module, wherein the external command is predefined in the baseboard management control module and is utilized for instructing a server module to access data of a device component. When receiving the external command, the baseboard management control module generates a first event to a chip module coupled to the server module, to trigger the chip module to generate a second event used for instructing the server module to access the device component. In such a condition, the user accesses the device component of the server module via the baseboard management control module, for storing or updating data to the device component of the server module when the server module is offline. Further, the user also can reset the server module via the baseboard management control module when the server module crashes and cannot connect to the network. After being reset, the server module actively read the event queue, to reset settings or to access storage component or any device components of the server device.

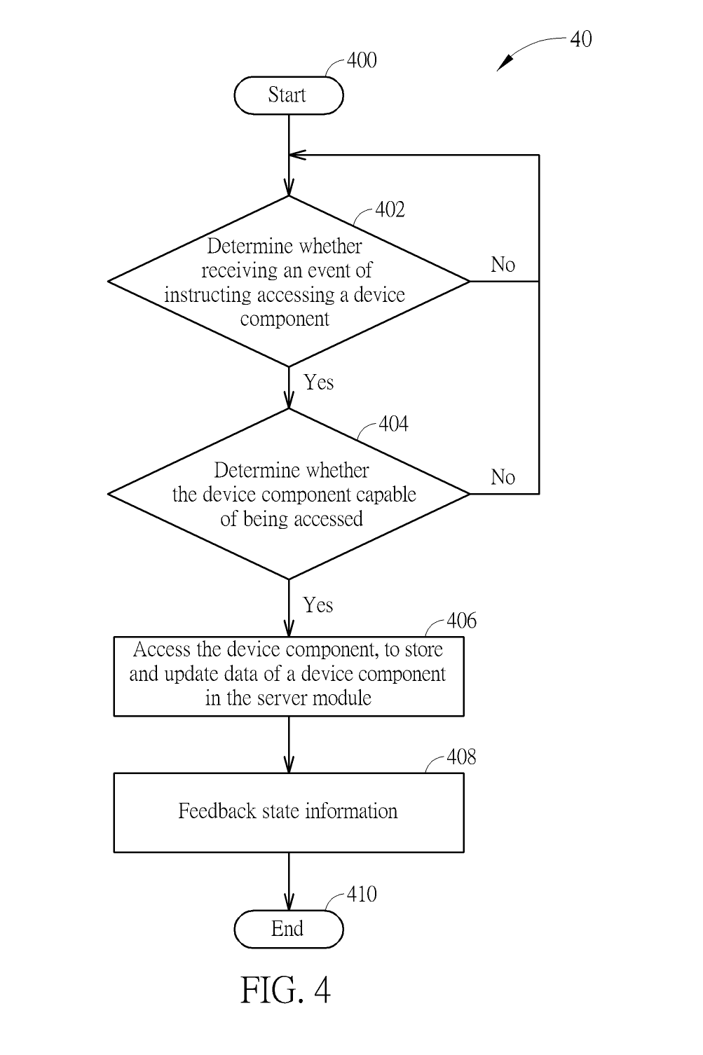

The process of the server module 104 accessing the device component 106 according to the event EVENT2 can be summarized in to an event processing method 40 shown in FIG. 4. The event processing method 40 is utilized in a server module of a server device which does not connected to the network and comprises the following steps:

Step 400: Start.

Step 402: Determine whether receiving an event of instructing accessing a device component. If yes, perform step 404; otherwise, perform step 402.

Step 404: Determine whether the device component capable of being accessed. If yes, perform step 406; otherwise, perform step 402.

Step 406: Access the device component, to store and update data of a device component in the server module.

Step 408: Feedback state information.

Step 410: End.

According to the event processing method 40, when a server module of the server device, which does not connect to the network, receives an event instructing accessing a device component (e.g. the event EVENT2), the server module determine whether the device component is ready to be accessed. If the device component is capable of being accessed, the server module accesses the device component, to store and to update data to the device component of the server module. In such a condition, the server module stores and updates data when being offline. Further, the user also can reset the server module via the baseboard management control module when the server module crashes and cannot connect to the network. After being reset, the server module actively read an event queue, to reset settings or to access data from any device component (e.g. memory components) of the server device. Finally, the server module feedbacks the state information for indicating whether the event is executed successfully.

To sum up, the baseboard management control module contains the external command which is pre-defined for instructing the server module to access data from a device component and the server module also contains the services corresponding to the external command. The user therefore can access the device component of the server module via the baseboard management control module, to store and update data to the device component of the server module when the server module is offline. In addition, the user also can reset the server module via the baseboard management control module when the server module crashes and cannot connect to the network, to control the server module to reset settings or to access any external device components via utilizing the server module to read the event queue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An accessing method, for a server device which does not connect to a network, the accessing method comprising:
inputting an external command to a baseboard management control module of the server device for triggering the baseboard management control module to generate a first event;
triggering a chip module of the server device to generate a second event according to the first event; and
accessing, by a server module of the server device, a device component according to the second event.

2. The accessing method of claim 1, wherein the external command is predetermined in an operation firmware of the baseboard management control module for instructing the server module to access data from the device component.

3. The accessing method of claim 1, wherein the chip module is a south bridge chip module.

4. The accessing method of claim 1, wherein the device component is an external device component coupled to the chip module via a connecting interface.

5. The accessing method of claim 1, wherein the device component is a virtual device configured in one of the chip module and the baseboard management control module.

6. A server device, comprising:
a base board management control module, for generating a first event when receiving an external command;
a chip module, coupled to the baseboard management control module for generating a second event when receiving the first event; and
a server module, coupled to the chip module for accessing a device component when receiving the second event.

7. The server device of claim 6, wherein the external command is predetermined in an operation firmware of the baseboard management control module, for instructing the server module to accessing data from the device component.

8. The server device of claim 6, wherein the chip module is a south bridge chip module.

9. The server device of claim 6, wherein the device component is an external device component coupled to the chip module via a connecting interface.

10. The server device of claim 6, wherein the device component is a virtual device configured in one of the chip module and the baseboard management control module.
